(19) United States
(12) Patent Application Publication
(10) Pub. No.: US 2015/0348152 A1
(43) Pub. Date: Dec. 3, 2015

(54) SOFTWARE PLATFORM FOR OPTIMIZING THE TRADE-IN VALUE OF VEHICLES AND METHOD OF USE THEREOF

(71) Applicant: James P. Battista, Elmwood Park, IL (US)

(72) Inventor: James P. Battista, Elmwood Park, IL (US)

(21) Appl. No.: 14/293,737

(22) Filed: Jun. 2, 2014

(51) Int. Cl. G06Q 30/06

(52) U.S. Cl. CPC G06Q 30/0611

(57) ABSTRACT

The present invention relates to a software platform, designed with an HTML Internet interface, and for portable phones (App format) to allow a full membership of car dealerships to operate in tandem via the system and platform to quickly and efficiently optimize the trade-in quote for a car of a potential buyer. Using a first device, a first agent of a dealer, if he or she cannot make a very good trade-in offer, will enter the vehicle data into the system which will immediately reach out the other members in a preferred format for issuance within a short time period of a revised an optimized quote.

### FIELD OF THE INVENTION

The present invention relates to a software platform, designed with an HTML Internet interface, and for portable phones (App format) to allow car dealerships to quickly and efficiently obtain a trade-in quote for a car of a potential buyer.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is an illustration of a trade-in evaluation system from the prior art.

FIG. 2 is an illustration of the hardware associated with the system described at FIGS. 5-10 of the present disclosure.

FIG. 3 is an illustration of one possible software layer to be used in the hardware shown at FIG. 2 to implement the system shown at FIGS. 5-10 of the present disclosure.

FIG. 4 is an illustration of one possible App based software layer used in the hardware shown at FIG. 2, relaying possibly on the software layer of FIG. 3 in part, to implement the system shown at FIGS. 5-10 of the present disclosure.

FIG. 5 is a diagram illustrating the different steps as part of the process of entering into a digital garage and enabling the a BuyFigure function according to an embodiment of the present disclosure.

FIG. 6 is a view of the digital garage illustrating the BuyFigure function according to an embodiment of the present disclosure.

FIG. 7 is a diagram illustrating the different steps associated with the process of the BuyFigure function as shown in FIGS. 5-6 according to an embodiment of the present disclosure.

FIGS. 8-10 are screen illustrations of a portable App format software for portable wireless phone illustrating the main features of this application.

### BACKGROUND

The automobile industry is a key component of the U.S. economy. It's diversity and complexity does not need to be demonstrated. Most adults own or have access to at least one vehicle which they drive on a daily basis. Many families own multiple vehicles. Millions of vehicles are sold each year, and the cost of vehicles is one of the most important part of a family's annual budget. While few customers know in detail the industry, they all are extremely attentive to new services or innovations that would result in helping lower the overall cost of a vehicle.

Vehicles manufactured in large plants in remote rural locations must find their way from these plants to urban centers for sale. As for most large ticket items, while online sales have tried to lower costs by removing intermediaries, very few individuals are able to purchase a vehicle sight-unseen. Buyers need to sit in vehicles, establish a connection with the product and the sales staff, and often test drive the car before it is purchased. In addition, since vehicles require service, maintenance, and repairs, owners want to know they can rely on a local and available team at a nearby location. The most commonly used model of sales in the United States is the car dealership.

Car dealerships, also known as ‘dealerships’ are a key turning plate in this process. A car dealership is a local distribution of new and used cars at the retail level. Dealerships contract with one or more automakers via a contract to license one or multiple brands over an area of sale. They then deliver users the needed services along a very wide spectrum. These dealerships employs a specialized sales force, a team of mechanics trained with the manufacturer brands and models, often stores or orders spare parts, offer recall and maintenance services, and process warranty claims. In 2013, the new car dealer market was close to $715 billion, and the used car industry almost $89 billion.

To help retain old customers, dealerships are engaged in a competitive war to provide clients with better services, which often includes more integrated services or solutions. For example, some dealerships now offer rental car services in case a vehicle is left at the dealership for overnight repair. Other dealerships offer rebates and attractive prices on integrated parts and services solutions. Some even offer espresso coffee. Other dealerships try to offer multiply types of vehicles from different manufacturers, but this dilutes a brand and often teams are unable to specialize in one product when several are offered in a comparative sales model.

One of the key way to lower the effective price of a new vehicle and thus to promote sales, is to find value in the existing vehicle used by the customer. This value is often called a trade-in value, which is different than a true resale value. Since a dealership is often a specialist of one brand, it may have trouble optimizing the trade-in value of a potential client's existing vehicle. For example, if the true resale value of a car is $5,000, a dealership who advertises this brand could resell the car $5,000, but would struggle to resale cars of a different make thus having to drop the price to $4,500. The dealership would also only be able to buy the car from the individual for $2,500 or $2,000 respectively to make its sale margin of $2,500 on the vehicle.

In the case of a trade-in, the value and sale margin is often calculated on the overall transaction. If the customer desires to buy a new car worth $30,000, which has a margin of $7,500 (cost to dealership of $22,250), buying the trade-in for the full $5,000 will reduce the price to the customer of the net transaction to $25,000, which will precipitate the sale. The dealership would then get only $2,500 of its margin on the new car, and have to sell the old car on its lot to recuperate as much of the margin as possible. This example illustrates simply why dealerships do not favor the model of transferring new car margin to a trade-in to create additional work. For this reason, the trade-in value is often a fraction of the real value of a car.

These trade-in values are also best optimized by the dealership offering the specific type of model and brand of the used car. As shown above, this dealership has the capacity to leverage a greater value for the vehicle and therefore can offer a greater trade-in value. For example, if a potential buyer desires to trade-in a Ferrari® to buy a BMW®, the BMW® dealership knows the resale market value of the used car, but will have to place the Ferrari® in its used cars inventory on a lot where often few clients are likely to have this need.

When a dealership acquires multiple off-brand models which ultimately it has to pay less than full market value to the customer, if these do not sell quickly, the vehicles depreciate in value quickly over time as they get older on lots. The dealership is given the option of transporting these vehicles, and putting them at a live auction. These auctions are often uncertain, and results in multiple unwanted costs for the dealership which include transportation, insurance, potential theft, and a commission of the auctioneer. Continuing the above example, a dealership able to sell a $5,000 value car for only $4,500 has no financial incentive of paying for the transportation and auction of a car for this $500. The current systems are inherently difficult, they forces dealerships to shy away from different brand car trade-in and in turn potential buyers unable to quickly sell their cars to the dealership for a good portion of the actual resale value will delay their purchases.

U.S. application Ser. No. 13/155,586, entitled System and Method for Introducing a Buyer to the Seller of a Vehicle Using Information Collected when Assessing the Trade-In value of the Vehicle, teaches a system using the internet where a dealership agent is given access to a live network of private party buyers interested in buying the vehicle. The requires bids to be generated by third parties as the potential buyer sits and awaits for the dealership to offer a value. Many field of information must be entered, and if no interested immediate buyer is found, the seller of the car is not given a quote. This system, is imprecise, time consuming and only burdens the overall buying experience. The dealer simply becomes a seller in charge of selling the car.

What is needed is a new system and method that allows a car dealership to offer a potential customer with a different brand car a greater trade-in value to help promote sales and transactions at a greater margin.

### SUMMARY

The present invention relates to a software platform, designed with an HTML Internet interface, and for portable phones (App format) to allow a full membership of car dealerships to operate in tandem via the system and platform to quickly and efficiently optimize the trade-in quote for a car of a potential buyer. Using a first device, a first agent of a dealer, if he or she cannot make a very good trade-in offer, will enter the vehicle data into the system which will immediately reach out the other members in a preferred format for issuance within a short time period of a revised an optimized quote.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

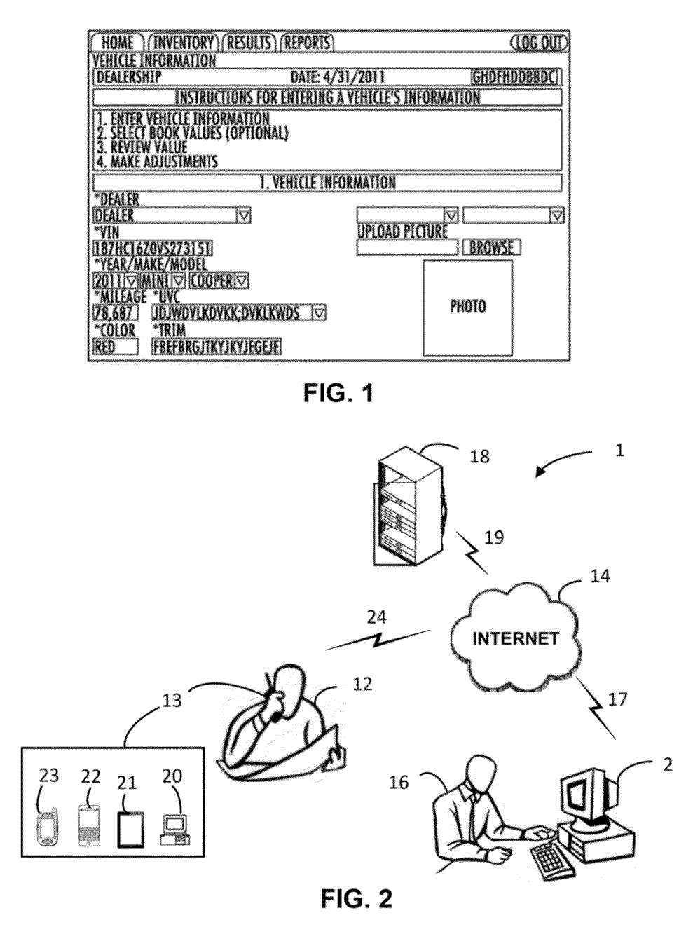

FIG. 1 shows one product currently defined in the prior art. FIG. 2 is an illustration of one possible hardware system 1 designed to hold a software platform or a software platform for optimizing the trade-in value of vehicles 100 shown in subsequent figures. In this configuration, the different actors (in this case multiple dealerships) will converge onto a common interface system 100 residing on a local computer system 2 or a remote server 18 as shown connected via the internet 14. A user 12, using a wireless or non-wireless device 13 or any other type of technology 23, 22, 21, 20 will log into the interface system 100 to take part of the marketplace and the exchange of vehicles. While the system as shown describes the exchange of vehicles between dealerships to optimize the trade-in value of a new buyer's old vehicle, one of ordinary skill in the art will recognize that the technology can be applicable to any field or industry where residual value is desired at the time of a deal where old goods retain residual value.

In this figure, two individuals are shown 12, 16 each at different positions of the system 1. One of ordinary skill will understand that information and software residing on these different pieces of hardware operate in tandem over a network such as the internet 14 or other wireless system to exchange information 17, 24, 19 to help the software reach the actors 12, 16. In the invention as described herein, the inventor uses both a HTML interface available to dealers online 16, and a App based software application to be uploaded form an App store and installed upon a dealer's personal cellphone. While the system can work on these two different layers of software, what is contemplated is the use of a single or more than two layers to interact to offer the same functions.

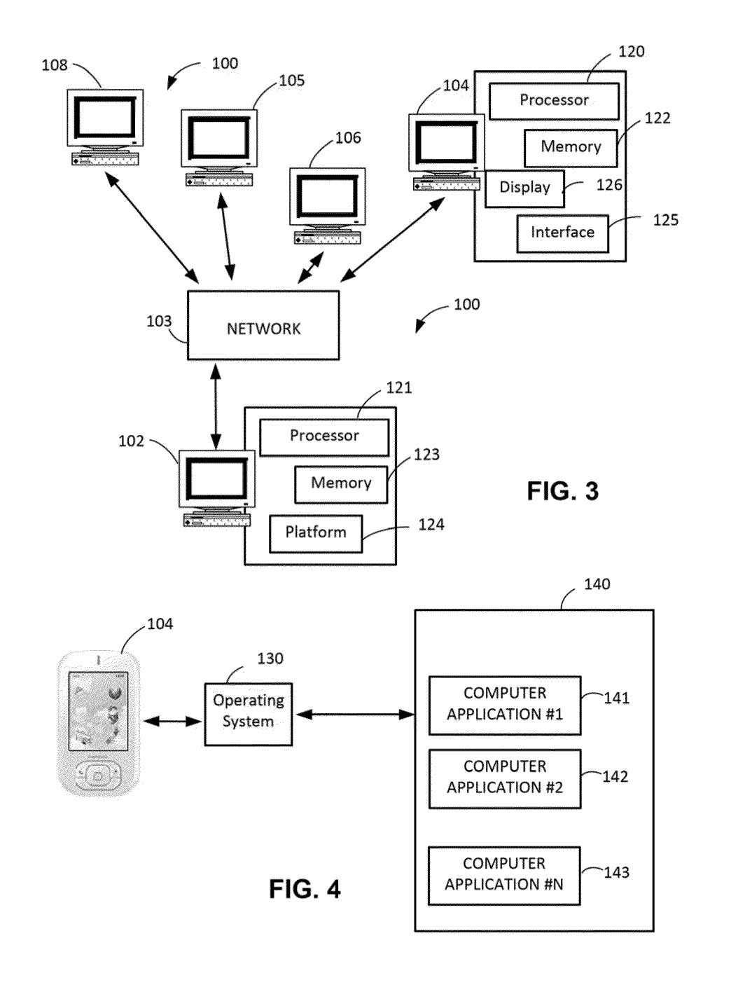

Hardware is nothing without the different software layers inhabiting the hardware. To help further define the hardware, each of the different portable or non-portable devices 2, 13, shown at FIG. 2 shown at FIG. 3 as 102, 104, 105, 106, and 108 each have different internal components needed for software to execute. For example, each computer 102, 104, 105, 106, and 108 or portable hand held device is connected to the network 103 and includes a processor 120, 121, which is connected to a memory 122, 123, which holds the software and executes the codes based on the different programming instructions of the device. In some cases, a host computer 102 as shown at FIG. 2 as the server 18 can host the platform/system 124 as shown. These devices also generally include a display 126 and an interface 125 such as a keyboard to help access the system via the display 126.

FIG. 4 shows how multiple computer applications 141, 142, and 143 can reside within the memory 123, 122 of the different devices. For example, a cell phone will have multiple computer applications 140 in memory each operating using an operating system 130 of the device 104. The structure shown at FIG. 2 is illustrative only generally of the technology layer in the form of hardware used by the different parties, for example the parties can use a web server or access an App store at which, for example, holds or sells different computer applications 141, 142, 143, which is uploaded via the network 103 to the device 104 for execution by the operating system 130 in the device 104.

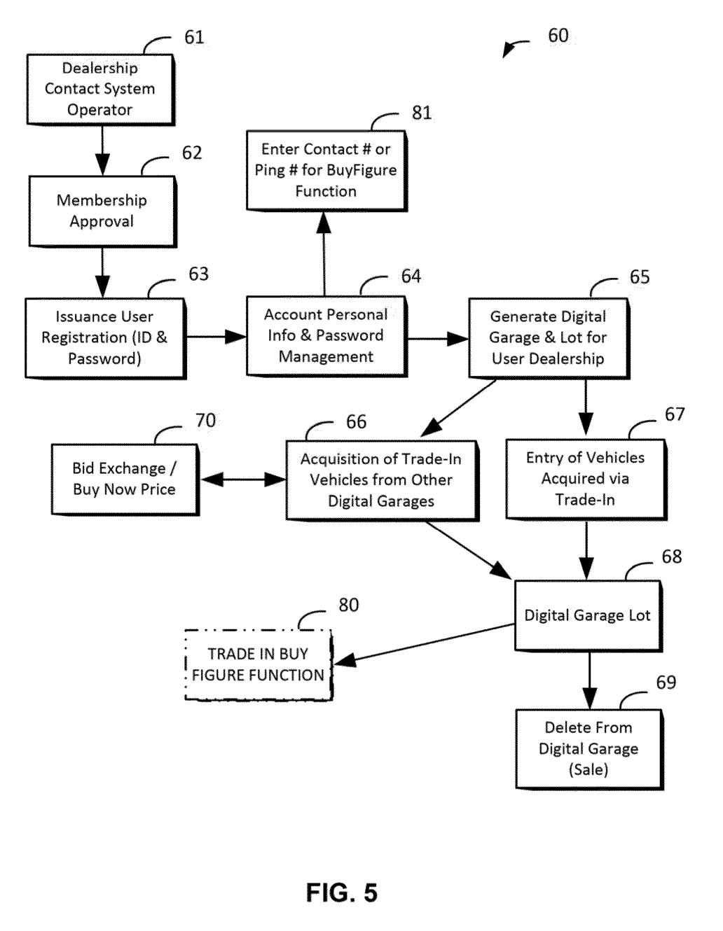

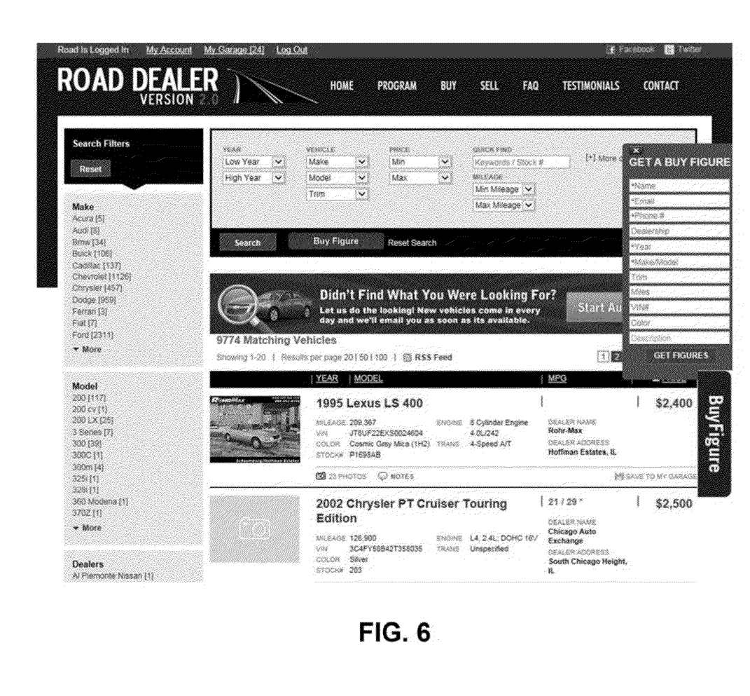

FIG. 5 shows the different functions 60 of the software platform for optimizing the trade-in value of vehicle. The software, shown at FIG. 6, is a system where an agent of a dealership 61 contacts a system operator for membership approval 62. The system operator vets the dealership and the agent and will issue the new user of the system (i.e. the dealership) 63 a registration identification number and an associated password. This user of the system or its agent will then access a personal account 64 to enter information and manage the password. Part of the information entered includes a contact number 81 or a ping number that will be used to reach the user when a buyfigure request is sent by a different agent using the system from a different dealership wanting to reach all of the membership to get offers that will help optimize the value to offer for trade-in.

The system 2 then generates 65 a digital garage as shown at FIG. 6, that is best understood as a digital garage and lot where the particular dealership vehicles offered at the dealership rate are listed. The agent of the dealership once the account is set up 64 and the new lot is created 65, can either enter vehicles acquired via trade-in 67 or then acquire vehicles from other digital garages by making offers of purchase 66 to populate the digital lot. These acquisitions are made by normal payment methods known in the industry including but not limited to electronic payment. The process 79 includes a normal exchange of bids and a buy it now price.

From the populated digital garage lot 68, as shown at FIG. 6, a user can delete car listings 69 if the real car is sold on a real lot of the dealership or can instantly get access to the trade-in buyfigure function 80 shown with greater detail at FIG. 6. This next figure shows how different tools and indexing tabs known can be used to breakdown the information and help guide the search for needed vehicles. This tools also helps a agent quote and give a trade-in value by looking at the price of equivalent cars made recently by competitive dealerships.

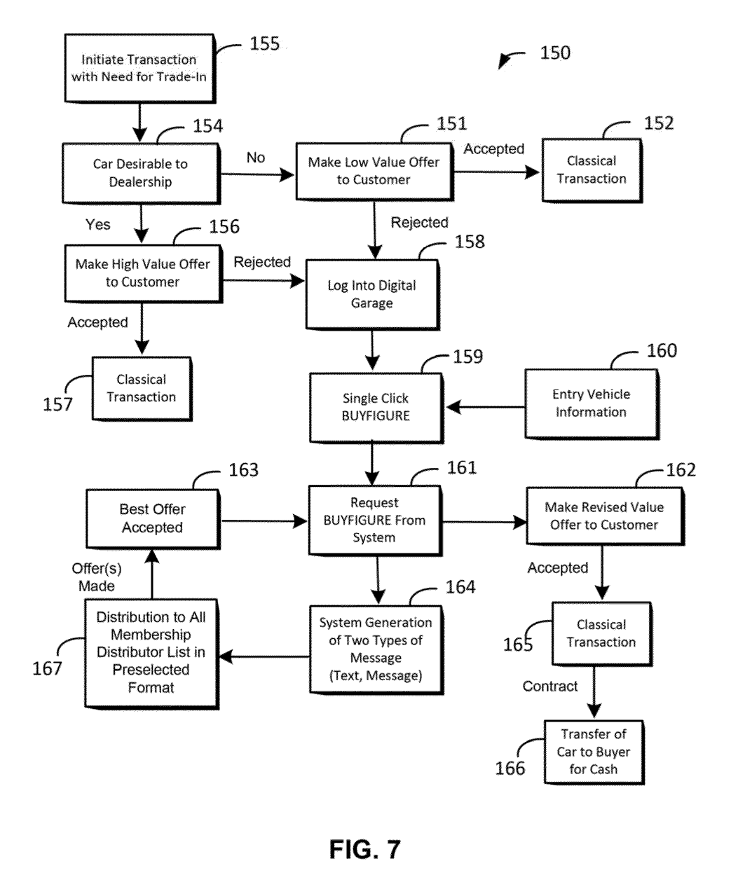

FIG. 7 in turn shows 150 the different steps and functions enabled when the buyfigure 80 button is clicked as shown at FIG. 6. First when a transaction is initiated 155 by an agent sitting in front of a customer having a need for a trade in, the agent will determine if the car is desirable 154 to the dealership. For example if the car is of a make and model that is desirable and can instantly lead to the highest possible value offer to the customer of trade-in. For example if the model matches the dealership model license contract. If the car is desirable, a high value offer will be made 156. If accepted, the transaction (i.e. the purchase with trade-in) is concluded 157. If the value is rejected, while improbable that any third party will beat the offer, the agent can log into the digital garage 158 of the software platform 2. On the reverse, if the car is not desirable to the dealer 154, a low value offer can be made to the customer 151. If the low offer is accepted 152, once again the transaction is concluded 152. If the offer is too low, the agent will log into the digital garage 158 to help enhance the potential trade-in value.

At the interface shown at FIG. 6, the agent will use the single click buyfigure 159 once the entry of vehicle information 160 has been made. A request for buyfigure is sent by the system 161 to all of the members of the system. The system generates one of several types of messages 164, either a text message or an email. The communications are pre-prepopulated by the system 167. Once distributed, cell phones and other portable devices of the different agents of the client dealerships will receive the message and can simply respond or call using the contact information in the message with a best offer. The best offer can then be accepted 163 by the agent sitting in front of the customer.

The agent then makes a revised value offer to the customer 162. In some cases, when no response is received, the agent will simply inform the customer that the system is working and that no dealership in the system will offer $1 more for the vehicle. Very often, the simple fact that the system returns no greater value indicates to the potential seller of the car that the low value offered initially is actually optimized for value. One a revised value offer is made 162, very often the classical transaction 165 will occur and transfer of contract value between the parties will occur 166.

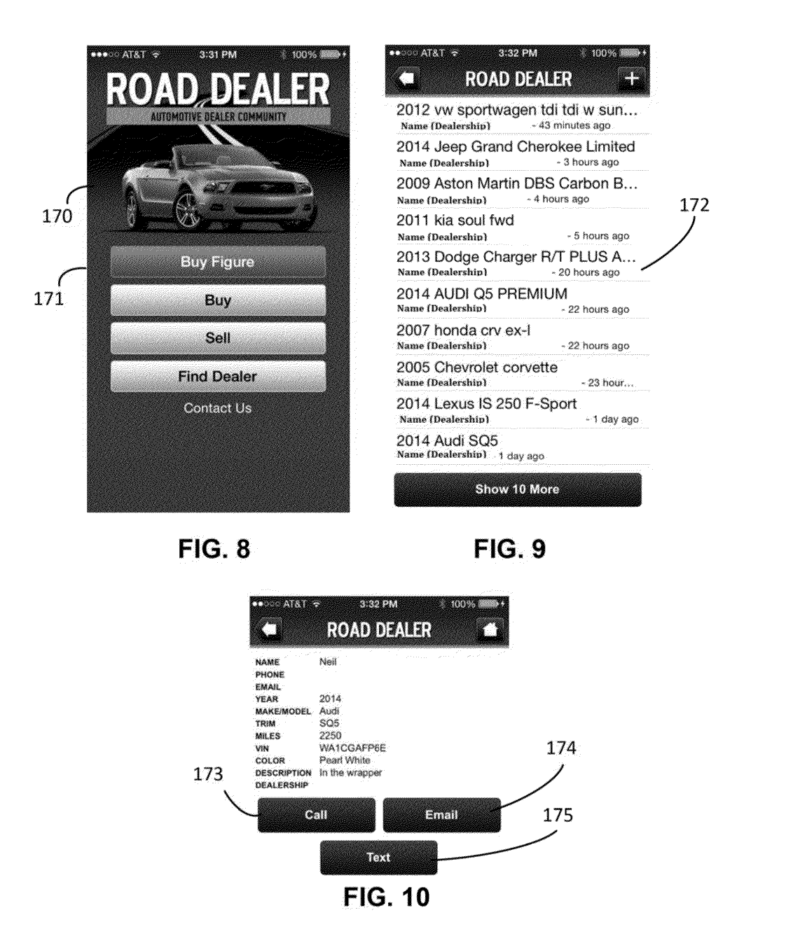

FIG. 8 shows a cover page of an App 170 to allow a user of a portable device to access the system. The first tab 171 is a once click button access to the buy figure. FIG. 9 illustrates the page of the App that lists all current buyfigure quotes outstanding 172. As shown, each vehicle is listed along with the information entered. For example, a user will receive a new text each time a new listing enters this database. By clicking on the list FIG. 10 is accessed. The user is given at this point a choice between calling 173, emailing 174, or texting 175 to the agent sitting with the customer. One of ordinary skill in the art will recognize that an agent may want to inform a customer that a buyfigure may be out for one day and can ask the client to return the next day to see if the initial offer can be optimized and increased with a revised offer. For example, if the agent can only comfortably offer $2,000 for a vehicle, he can list the car and request best offers. If three offers of sale are receive at $2,300, $2,500 and $2,100, the agent can call the customer informing him/her that he can increase the value of the trade-in by $500 and then using the interface system accept the $2,500 offer once the client has agreed to the transaction.

What is described above is a software platform 124 for optimizing the trade-in value of vehicles, the platform 124 comprising at least a portable device 13 as shown at FIG. 2 in possession of a first agent 12 of a first dealership with a potential need for a vehicle (not shown), the portable device 13 or shown as 104 at FIG. 3 having at least a computer processing unit 120 (CPU) for executing in a memory 122 connected to the CPU 120 a plurality of computer applications 141, 142, 143 as shown at FIG. 4, operating in a computer operating system environment 130, a display 126 connected to the CPU 120 for displaying at least one of the plurality of computer applications 141, 142, 143 as a tool for access of a software system 124 for optimizing the trade-in value of the vehicle.

The system includes a user interface 125 connected to the CPU 120 for interaction with the at least one of the plurality of computer applications 141, 142, 143 being displayed on the display 126, and at least a second device 108, 105, or 106 at FIG. 3 in possession of a second agent 16 of a second dealership in contact with a customer having a desired to trade-in the vehicle, the second 108, 105, or 106 device also having a CPU (for example 121 od 102) for executing in its own memory 123 connected to the CPU 121 the software system 124 for optimizing the trade-in value of the vehicle accessed by the portable device 104 of the first agent. The software system for optimizing the trade-in value of the vehicle includes a dealership account set-up portion 64, a digital garage lot 68 associated with the dealership account for entry of at least one vehicle acquired via trade-in 67, and a buyfigure function 80.

The software system further includes a portion within the account set-up portion for entry of a contract number or a ping number for receiving a buyfigure offer. further including a module for the acquisition of trade-in vehicle from other digital garages. wherein the acquisition of the trade-in vehicle includes a bid exchange process or a buy now price entry to buy the vehicle. wherein the buyfigure function is a single click-based module processing the identification of the vehicle for pricing by a plurality of agents of dealerships.

The identification of the vehicle 160 as shown at FIG. 7 can include as shown at FIG. 6 a contact information of the second agent and the contact information of the second dealership, a year, a make/model, a trim, a number of miles, the vehicle's vehicle identification number, a color, a description and an image. The buyfigure function 80 is a module which with allows the plurality of agents of dealerships to send at least one revised value offer 167 to buy the vehicle by the second agent from the first agent. The revised value offer 162 as the best offer accepted 163 can be greater than a low value offer 151 made by the second agent if the vehicle is of a model different than a model associated with the first dealership.

What is also contemplated is a method a method of optimizing the trade-in value of a vehicle using a software platform for optimizing the trade-in value of vehicles, the method comprising the steps of allowing the second agent to make a first value offer to the customer, and if the first value offer is rejected by the customer, allowing the second agent to access the software platform to obtain from the first agent a revised value offer greater than the first value offer. The step of obtaining from the first agent the revised value includes the steps of allowing the second agent to log into the software platform into a digital garage, using a single click buyfigure function, allowing the software platform to issue a message to all agents of all distributors in a list using the software platform, and receiving at least one offer as the revised value offer.

Further, what is contemplated is the single click buyfigure function includes a step where the second agent enters an identification of the vehicle which comprises a contact information of the second agent and the contact information of the second dealership, a year, a make/model, a trim, a number of miles, the vehicle's vehicle identification number, a color, a description and an image, or where the revised value offer is greater than the first value offer.

It is understood that the preceding is merely a detailed description of some examples and embodiments of the present invention and that numerous changes to the disclosed embodiments may be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A software platform for optimizing the trade-in value of vehicles, the platform comprising:
at least a portable device in possession of a first agent of a first dealership with a potential need for a vehicle, the portable device having at least a computer processing unit (CPU) for executing in a memory connected to the CPU a plurality of computer applications operating in a computer operating system environment, a display connected to the CPU for displaying at least one of the plurality of computer applications as a tool for access of a software system for optimizing the trade-in value of the vehicle, and a user interface connected to the CPU for interaction with the at least one of the plurality of computer applications being displayed on the display; and
at least a second device in possession of a second agent of a second dealership in contact with a customer having a desired to trade-in the vehicle, the second device also having a CPU for executing in its own memory connected to the CPU the software system for optimizing the trade-in value of the vehicle accessed by the portable device of the first agent;
wherein the software system for optimizing the trade-in value of the vehicle includes a dealership account set-up portion, a digital garage lot associated with the dealership account for entry of at least one vehicle acquired via trade-in, and a buyfigure function.

2. The software platform of claim 1, wherein the software system further includes a portion within the account set-up portion for entry of a contract number or a ping number for receiving a buyfigure offer.

3. The software platform of claim 2, further including a module for the acquisition of trade-in vehicle from other digital garages.

4. The software platform of claim 3, wherein the acquisition of the trade-in vehicle includes a bid exchange process or a buy now price entry to buy the vehicle.

5. The software platform of claim 1, wherein the buyfigure function is a single click-based module processing the identification of the vehicle for pricing by a plurality of agents of dealerships.

6. The software platform of claim 1, wherein the identification of the vehicle comprises a contact information of the second agent and the contact information of the second dealership, a year, a make/model, a trim, a number of miles, the vehicle's vehicle identification number, a color, a description and an image.

7. The software platform of claim 6, wherein the buyfigure function is a module which with allows the plurality of agents of dealerships to send at least one revised value offer to buy the vehicle by the second agent from the first agent.

8. The software platform of claim 7, wherein the revised value offer is greater than a low value offer made by the second agent if the vehicle is of a model different than a model associated with the first dealership.

9. A method of optimizing the trade-in value of a vehicle using a software platform for optimizing the trade-in value of vehicles, the platform comprising at least a portable device in possession of a first agent of a first dealership with a potential need for a vehicle, the portable device having at least a computer processing unit (CPU) for executing in a memory connected to the CPU a plurality of computer applications operating in a computer operating system environment, a display connected to the CPU for displaying at least one of the plurality of computer applications as a tool for access of a software system for optimizing the trade-in value of the vehicle, and a user interface connected to the CPU for interaction with the at least one of the plurality of computer applications being displayed on the display, and at least a second device in possession of a second agent of a second dealership in contact with a customer having a desired to trade-in the vehicle, the second device also having a CPU for executing in its own memory connected to the CPU the software system for optimizing the trade-in value of the vehicle accessed by the portable device of the first agent, wherein the software system for optimizing the trade-in value of the vehicle includes a dealership account set-up portion, a digital garage lot associated with the dealership account for entry of at least one vehicle acquired via trade-in, and a buyfigure function, the method comprising the steps of:
allowing the second agent to make a first value offer to the customer, and if the first value offer is rejected by the customer;
allowing the second agent to access the software platform to obtain from the first agent a revised value offer greater than the first value offer.

10. The method of claim 9, wherein the step of obtaining from the first agent the revised value includes the steps of:
allowing the second agent to log into the software platform into a digital garage;
using a single click buyfigure function;
allowing the software platform to issue a message to all agents of all distributors in a list using the software platform; and
receiving at least one offer as the revised value offer.

11. The method of claim 10, wherein the message sent is a text or an email sent to a contact number of a ping number entered by each of the distributors into their own personal accounts on the system.

12. The method of claim 11, wherein the software platform further including a module for the acquisition of trade-in vehicle from other digital garages.

13. The method of claim 11, wherein the acquisition of the trade-in vehicle includes a bid exchange process or a buy now price entry to buy the vehicle.

14. The method of claim 11, wherein the single click buyfigure function includes a step where the second agent enters an identification of the vehicle which comprises a contact information of the second agent and the contact information of the second dealership, a year, a make/model, a trim, a number of miles, the vehicle's vehicle identification number, a color, a description and an image.

15. The method of claim 10, wherein the revised value offer is greater than the first value offer.
